(19) United States
(12) Patent Application Publication
(10) Pub. No.: US 2023/0267905 A1
(43) Pub. Date: Aug. 24, 2023

(54) NOISE BARRIER AND APPARATUS COMPRISING THE NOISE BARRIER

(71) Applicant: RECTICEL ENGINEERED FOAMS BELGIUM, Brussels (BE)

(72) Inventors: Mathieu GONTIER, Trilport (FR); Paul DE ROOVER, Wetteren (BE); Jonas CHOUWER, Wetteren (BE); Mario GENETELLO, Wetteren (BE)

(21) Appl. No.: 18/005,587

(22) PCT Filed: Jul. 16, 2021
(86) PCT No.: PCT/EP2021/069953

§ 371 Date: Jan. 13, 2023

(30) Foreign Application Priority Data
Jul. 17, 2020 (EP) 20186431.1

(51) Int. Cl. G10K 11/162; G10K 11/16

(52) U.S. Cl. CPC G10K 11/162; G10K 11/161

(57) ABSTRACT

A noise barrier is adapted for use in an apparatus which produces noise during operation and which includes at least one blower for generating an airflow along a path through the apparatus. The noise barrier has one or more through holes and is configured to be placed in the path of the airflow for attenuating sound which propagates along the path in the airflow. The noise barrier is made of at least one sound attenuating polymeric foam, in particular a polyurethane foam. In order to achieve better sound attenuating properties the polymeric foam of the noise barrier has an airflow resistivity, measured in accordance with ISO 9053-1:2018, Part 1, which is higher than 50 000 Ns/m⁴. Moreover, the dynamic Young's modulus of the polymeric foam is preferably smaller than 250 kPa.

The present invention relates to a noise barrier which is configured to be placed in the path of an airflow for attenuating sound which propagates along this path in the airflow. The noise barrier has one or more through holes to enable the airflow to pass through the noise barrier. The noise barrier is made of at least one sound attenuating polymeric foam, in particular a polyurethane foam. It has one side which is configured to be hit by the air of the airflow over a surface section which has a predetermined surface area in an orthogonal projection on a plane fitted to said surface section.

There are a lot of installations, apparatuses, equipment wherein an airflow is generated along a certain path, generally from an inlet to an outlet, and wherein at the same time sound/noise propagates along this same path. Noise barriers can be used to attenuate this propagation of sound out of the installation, apparatus or equipment, either in the direction of said airflow or in the opposite direction. They can in particular be used in air-cooled apparatuses wherein an airflow is generated for cooling purposes. The apparatus may for example be a genset (i.e. an engine-generator used to generate electricity), an air compressor, a data storage compartment, a refrigerator, etc. The noise barriers can also be used in other apparatuses which generate an airflow, for example in a dust collector, a vacuum cleaner, and a heating/ventilation/air conditioning apparatus (HVAC) or wherein an airflow is generated, for example in a ventilation apparatus.

U.S. Pat. No. 7,712,576 discloses noise barriers, more particularly sound absorbing structures for electronic equipment. The electronic equipment comprises a blower for blowing cooling air along the equipment. According to the prior art section of this US patent, it was already known to place relatively thick pieces of sound absorbing polymeric foam in front of the blowers, in between which a channel is provided to enable the cooling air to flow through these pieces of foam. A drawback of such a noise barrier is the required thickness of the foam, which puts restrictions on the installation space, handling, etc. To make the noise barrier more effective, U.S. Pat. No. 7,712,576 proposes to make louvers of polyurethane foam and to fix them to one another in an inclined position relative to the airflow so that the noise cannot pass in a straight line through the slots in the noise barrier. The noise can therefore not pass through the noise barrier without hitting the foam material and being absorbed thereby. The louvers themselves can not only be inclined but may also have a V-shape or a U-shape in a cross-sectional view.

The nature of the polyurethane foam material used to make the louvers is not disclosed in U.S. Pat. No. 7,712,576. However, it inherently should have a relatively high rigidity because the different polyurethane louvers are provided on both sides with threaded holes to enable to fix them by means of screws to the frame of the sound absorbing structure.

In the article “Effect of non-acoustic properties on the sound absorption of polyurethane foams” of Asadi et al. in the Journal of Theoretical and Applied Vibration and Acoustics, 1(2) 122-132 (2015) the effect of different properties of polyurethane foams on the sound absorption coefficients thereof are described. These properties include the Biot parameters, namely the porosity of the foam, the airflow resistivity, the tortuosity, the viscous characteristic length and the thermal characteristic length. For the different frequencies, the sound absorption coefficient was found to increase with increasing airflow resistivity. Tests were done with foams having airflow resistivities ranging from 500 to about 20 000 N.s/m⁴. According to the authors, an optimum value exists for airflow resistivity because a further increase of the airflow resistivity will prevent acoustic wave to penetrate into the foam.

WO 00/15697 discloses thermoplastic polymer foams for use as a sound deadening material. These foams are mechanically punched with needles to open the cells in order to obtain a sufficiently low airflow resistivity to be suitable for use as a sound absorption material. In general, it was found that the smaller the specific air flow resistance, the greater the sound absorption coefficient of the punched foam. The airflow resistivity of the punched foam was most preferably smaller than 50 000 N.s/m⁴.

U.S. Pat. No. 5,504,281 discloses a noise barrier which does not comprise a polymeric foam but which consists instead a porous material comprised of particles sintered and/or bonded together at their points of contact. The porous material has an interstitial porosity of only about 20 to about 60 percent. It has a very high Young's modulus which is equal to 82 737 kPa or even much higher. If the modulus would be lower, the sound attenuation would become poor. The attenuation of the sound by this acoustical material was comparable to mass law performance. In the examples through holes were made in the noise barrier which occupied only a few percent of the surface area of the noise barrier. By using glass microbubbles as particles, the porous material enabled to achieve comparable insertion loss values but better back pressure performance with less mass when compared to non-porous particle board. The porous material however still had a density of about 200 kg/m³.

An object of the present invention is to provide a new noise barrier which is made of a polymeric foam and which has improved sound attenuating properties.

To this end, the noise barrier according to the present invention is characterised in that the polymeric foam of the noise barrier has an airflow resistivity, measured in accordance with ISO 9053-1:2018, Part 1, which is higher than 50 000 Ns/m⁴, and in that the one or more through holes of the noise barrier each have a centreline and a smallest cross-sectional area, measured in a plane perpendicular to its centreline, the sum of said smallest cross-sectional areas being larger than 10% of said predetermined surface area of the surface section of the noise barrier which is hit by the airflow.

The sum of the smallest cross-sectional areas of the through holes in the noise barrier is referred to hereinafter as the open surface of the noise barrier. The polymeric foam is defined as a cellular foam formed by a polymeric material, the cells of the foam being formed by a foaming process.

The present inventors have done acoustic tests, more particularly transmission loss tests, with noise barriers made of polymeric foams having different airflow resistivities. They found rather surprisingly that when further increasing the airflow resistivity of the polymeric foam to values higher than 50 000 Ns/m⁴, the acoustic performance of the perforated noise barrier was still considerably improved.

In an embodiment of the noise barrier according to the present invention said polymeric foam is a polyurethane foam.

Different polyurethane foams are available, or can be made, to achieve the desired acoustic properties.

In an embodiment of the noise barrier according to the present invention, or according to the preceding embodiment, said polymeric foam has an open porosity of at least 80%, preferably of at least 90%, as measured according to the publication “Méthode de la masse manquante” as published in the Journal of Applied Physics 101 (12), 2007.

The open porosity is defined as the fraction of the interconnected air volume to the total volume of the polymeric foam. The open porosity was found to improve the noise attenuating properties of the noise barrier which is provided with through holes. The open porosity enables the noise to pass more easily through the foam itself but nevertheless it was found to improve the noise attenuating properties of the foam when provided with through holes. A higher open porosity was found to increase the noise absorption and to enable less noise to pass the noise barrier through the holes thereof.

In an embodiment of the noise barrier according to the present invention, or according to any one of the preceding embodiments, said polymeric foam has a dynamic Young's modulus, measured in accordance with ISO 18437-5:2011, lower than 400 kPa.

In an embodiment of the noise barrier according to the present invention, or according to any one of the preceding embodiments, said airflow resistivity is higher than 80 000 Ns/m⁴, preferably higher than 140.000 Ns/m⁴ and more preferably higher than 200 000 Ns/m⁴.

The present inventors have found rather surprisingly that when further increasing the airflow resistivity of the polymeric foam to such high values, the acoustic performance of the perforated noise barrier was still considerably improved notwithstanding the increased reflection of the sound waves by the polymeric foam of the noise barrier.

In an embodiment of the noise barrier according to the present invention, or according to any one of the preceding embodiments, said airflow resistivity is lower than 1 000 000 Ns/m⁴, preferably lower than 800.000 Ns/m⁴ and more preferably lower than 600 000 Ns/m⁴.

The airflow resistivity is preferably kept below these upper limits to maintain a suitable balance between the reflection and absorption properties of the polymeric foam so that an improved acoustic performance of the noise barrier is achieved.

In an embodiment of the noise barrier according to the present invention, or according to any one of the preceding embodiments, said polymeric foam has a dynamic Young's modulus, measured in accordance with ASTM 18437-5:2011, lower than 250 kPa, preferably lower than 200 kPa.

It was found that for some polymeric foams having a high airflow resistivity, the transmission loss showed a peak in the low frequency range, i.e. in the range of 100 to 2000 Hz and that this peak could be avoided by using a polymeric foam having a lower dynamic Young's modulus.

In an embodiment of the noise barrier according to the present invention, or according to any one of the preceding embodiments, said polymeric foam has a static Young's modulus, measured in accordance with ISO 14125:1998/Amd 1:2011, higher than 20 kPa, preferably higher than 30 kPa and more preferably higher than 50 kPa.

An advantage of such a higher static Young's modulus is that the foam has a higher stiffness and can thus resist better the forces exerted thereon by the airflow hitting the noise barrier.

In an embodiment of the noise barrier according to the present invention, or according to any one of the preceding embodiments, said sum of said smallest cross-sectional areas is larger than 20% and preferably larger than 30% of said predetermined surface area.

This embodiment enables a higher airflow through the noise barrier. Especially for such a higher open surface, the higher airflow resistance of the polymeric foam of the noise barrier enables to achieve improved noise attenuating properties.

In an embodiment of the noise barrier according to the present invention, or according to any one of the preceding embodiments, said sum of said smallest cross-sectional areas is smaller than 60% and preferably smaller than 50% of said predetermined surface area.

Open surface contents below said upper limits enable to achieve better noise attenuating properties, in particular a larger acoustic transmission loss.

In an embodiment of the noise barrier according to the present invention, or according to any one of the preceding embodiments, said through holes have at the location of their smallest cross-sectional area, and measured in said plane perpendicular to their centreline at their smallest cross-sectional area, a longest diameter passing through said centreline and a shortest diameter passing through said centreline, which shortest diameter is larger than 30%, preferably larger than 50% of said longest diameter.

An advantage of such a cross-sectional shape of the through holes is that the polymeric foam separating the through holes has a larger mechanical strength so that the noise barrier may resist higher airflow rates, especially in case the polymeric foam has a static Young's modulus between the hereinabove defined upper and lower limits. It has been found that for example louvers, as described and illustrated in U.S. Pat. No. 7,712,576, have a smaller mechanical strength compared to through holes which are cut in the polymeric foam and which do not have such a large length.

In an embodiment of the noise barrier according to the present invention, or according to any one of the preceding embodiments, more than 80% of the sum of said smallest cross-sectional areas is formed by less than 20, preferably less than 15 and more preferably less than 10 of the through holes which have the largest ones of said smallest cross-sectional areas.

It was found that an increase of the size of the through holes has a smaller effect on the acoustic performance of the noise barrier than an increase of the open surface thereof, i.e. of the sum of the smallest cross-sectional areas of the through holes. Larger through holes have the advantage that they offer less resistance to the air that has to flow through the noise barrier than smaller through holes, for a same open surface content of the noise barrier. Consequently, it was found that a better acoustic performance could be achieved with fewer but larger through holes, providing a smaller total open surface but still enabling the required air flowrate through the noise barrier. It is indeed known that larger holes offer less resistance to the airflow so that a smaller open surface content is already sufficient to achieve the desired air permeability.

In an embodiment of the noise barrier according to the present invention, or according to any one of the preceding embodiments, said through holes have an inlet and an outlet for said airflow, and comprise through holes which have a cross-sectional area, measured in a plane perpendicular to their centreline at the location of their inlet, which is larger than their cross-sectional area, measured in a plane perpendicular to their centreline at the location of their outlet.

Such holes, which are preferably conical, can offer an improved acoustic performance compared to a through hole which has a constant cross-section and which has a same airflow resistance.

In an embodiment of the noise barrier according to the present invention, or according to any one of the preceding embodiments, said through holes comprise through holes having such a shape that no straight line passes therethrough.

Since the noise cannot pass along a straight line through these holes, the sound attenuating properties, in particular the transmission loss, of the noise barrier is improved compared to a noise barrier having through holes wherein a straight line can pass through.

In an embodiment of the noise barrier according to the present invention, or according to any one of the preceding embodiments, said through holes comprise through holes having a centreline which is not rectilinear and/or which forms an angle smaller than 80° with said fitted plane.

Such non-rectilinear through holes, or such inclined through holes, will increase the absorption of the sound passing through the holes.

In an embodiment of the noise barrier according to the present invention, or according to any one of the preceding embodiments, said through holes are made by removing material from said foam, said through holes being preferably cut in said foam.

When the through holes are made by removing foam material, the noise barrier does not need to be assembled from different foam pieces. Cutting the through holes is not only easier and cheaper than assembling different pieces but the polymeric foam may also have a smaller stiffness as the noise barrier is made of one piece. Moreover, a cut foam surface has a higher roughness and may therefore absorb more acoustic energy. This is especially advantageous for the noise barrier of the present invention wherein the polymeric foam has a quite high airflow resistance so that the sound waves penetrate less easily into the polymeric foam to be absorbed therein.

In an embodiment of the noise barrier according to the present invention, or according to any one of the preceding embodiments, it mainly consists of said polymeric foam.

The noise barrier is thus easy to produce since it has only to be produced from the polymeric foam. It may for example be cut out of a plate of a block of the polymeric foam. The expression “mainly consists” means in particular that the noise barrier, in particular that portion thereof which is placed in the airflow, consists for at least 80 wt. %, preferably for at least 90 wt. % of the polymeric foam.

In an embodiment of the noise barrier according to the present invention, or according to any one of the preceding embodiments, said foam has a density of less than 100 kg/m³, preferably of less than 80 kg/m³. Preferably, the density of the foam is higher than 15 kg/m³ and more preferably higher than 20 kg/m³.

Within this density range polymeric foams are available having the properties within the ranges defined hereinabove and having also the required mechanical properties for being used as a noise barrier which can resist to the airflow wherein it is placed.

In an embodiment of the noise barrier according to the present invention, or according to any one of the preceding embodiments, it is placed in the path of an airflow for attenuating sound propagated along this path.

In an embodiment of the noise barrier according to the present invention, or according to any one of the preceding embodiments, it is placed in the path of an airflow wherein noise is propagated.

In an embodiment of the noise barrier according to the present invention, or according to any one of the preceding embodiments, said one or more through holes comprise at least one through hole of which said smallest cross-sectional area is larger than 0.2 cm², or larger than 1.0 cm², or larger than 5.0 cm², or larger than 10.0 cm². Preferably, the smallest cross-sectional area of this through hole is smaller than 500 cm², or smaller than 400 cm² or smaller than 300 cm².

Through holes having such minimum cross-sectional areas are effective to allow the airflow to pass. Larger through holes offer relatively less resistance to the flow of air so that the total open surface, defined by the sum of said minimal cross-sectional areas, may be reduced. In this way, the acoustic performance of the noise barrier can be improved.

The present invention also relates to an apparatus which produces noise during operation and which comprises at least one blower for generating an airflow along a path through the apparatus. According to the invention this apparatus is characterised in that it comprises a noise barrier according to the invention which is placed in said path of said airflow.

In an embodiment of the apparatus according to the present invention, said apparatus is an air-cooled apparatus which is cooled by said airflow.

In another embodiment of the apparatus according to the present invention, said apparatus is an air blowing and/or an air sucking apparatus configured to suck in air from the environment and/or to blow air into the environment, the apparatus being in particular a dust collector or a heating and/or a cooling apparatus.

Other advantages and particularities of the present invention will become apparent from the following description of some particular embodiments of the noise barrier and of the apparatus according to the invention. This description is only given by way of example and is not intended to limit the scope of the invention. The reference numerals used in the description relate to the annexed drawings wherein:

FIG. 1 is a schematic perspective view on an apparatus according to the present invention;

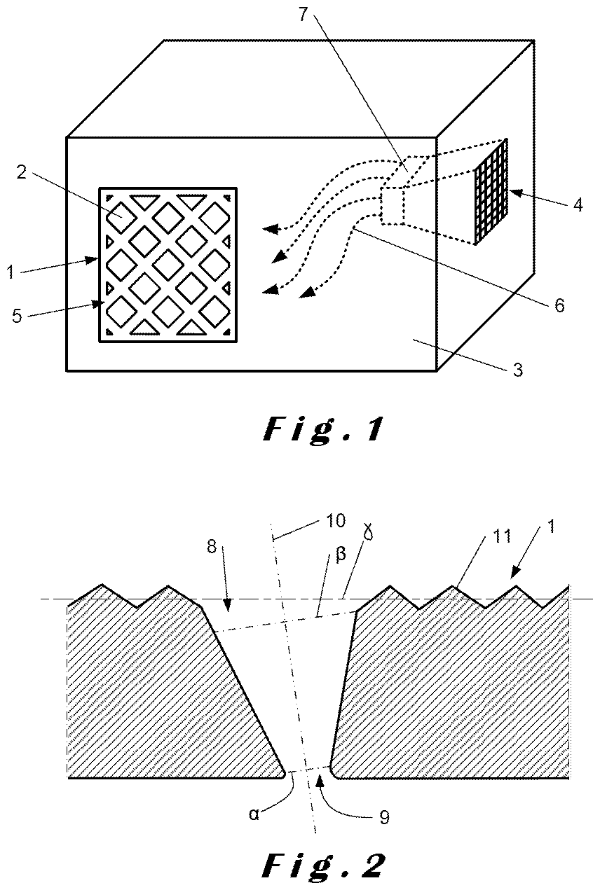

FIG. 2 is a section through a portion of a noise barrier according to the present invention at the location of a through hole thereof;

FIG. 3 is a front view of the noise barrier applied in the apparatus shown in FIG. 1 and having a honeycomb structure;

FIG. 4 is a cross-sectional view along lines IV-IV in FIG. 3;

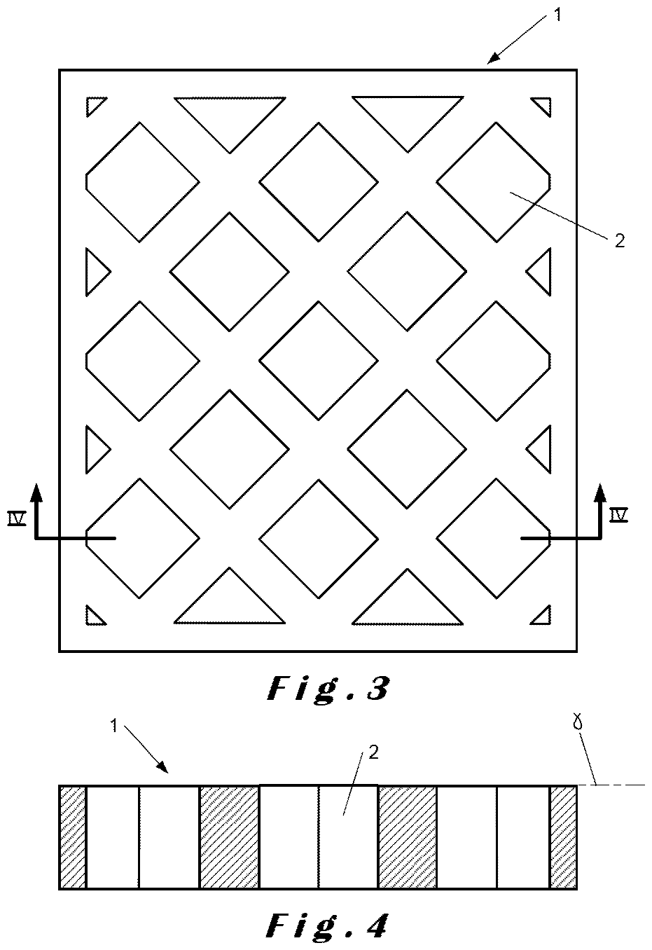

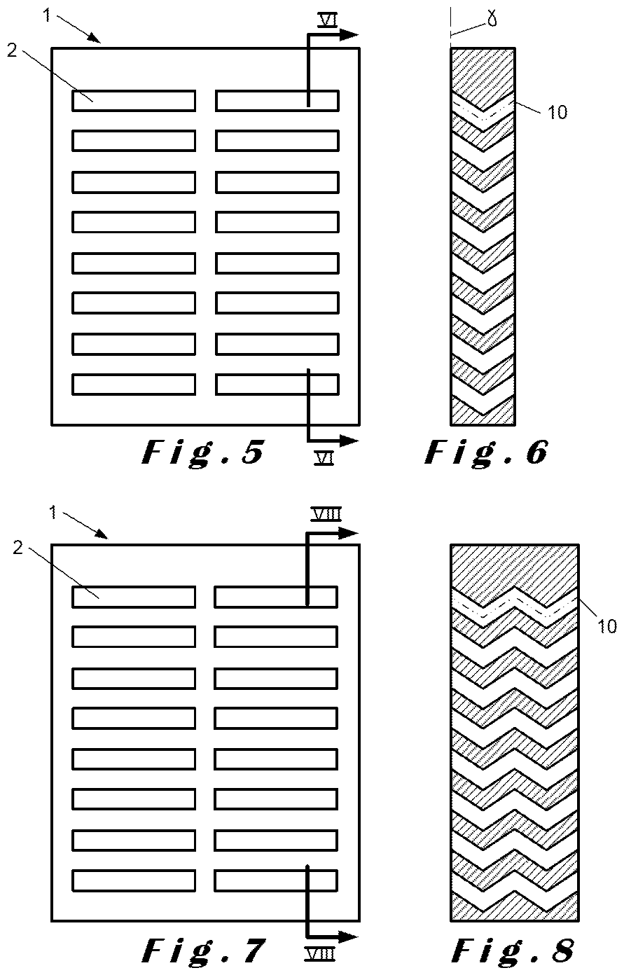

FIG. 5 is a front view of another embodiment of the noise barrier according to the invention which is made up of louvers;

FIG. 6 is a cross-sectional view along lines VI-VI in FIG. 5 showing the V-shaped structure of the louvers;

FIG. 7 is a front view of still another embodiment of the noise barrier according to the invention which is made up of louvers;

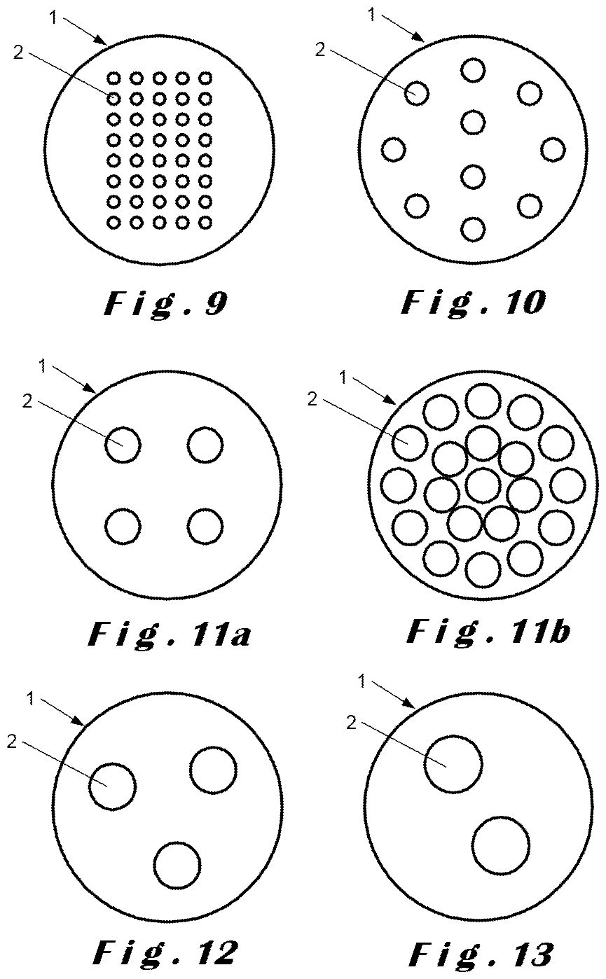

FIG. 8 is a cross-sectional view along lines VIII-VIII in FIG. 7 showing the W-shaped structure of the louvers;

FIGS. 9, 10, 11a, 11b, 12 and 13 are front views of cylindrical noise barriers which have been tested in the impedance tube experiments;

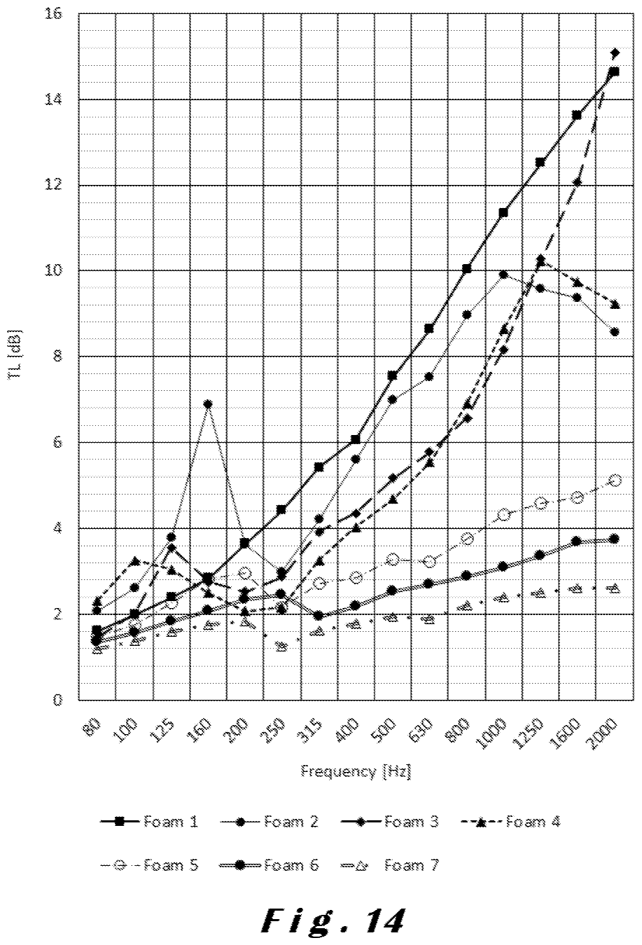

FIG. 14 is a graph of the transmission losses obtained for different foams in the impedance tube experiments with the noise barrier shown in FIG. 11a;

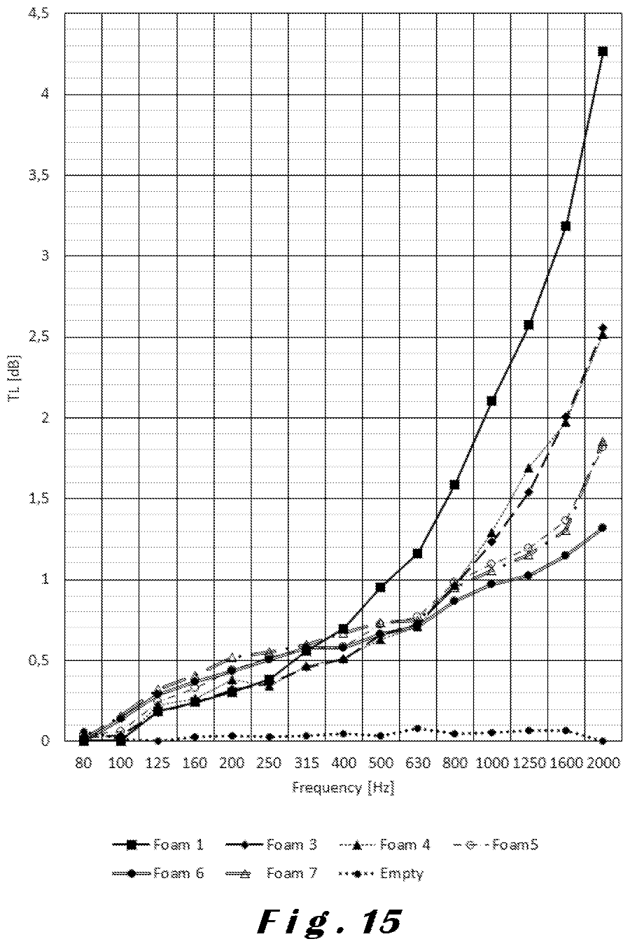

FIG. 15 is a graph of the transmission losses obtained for different foams in the impedance tube experiments with the noise barrier shown in FIG. 11b;

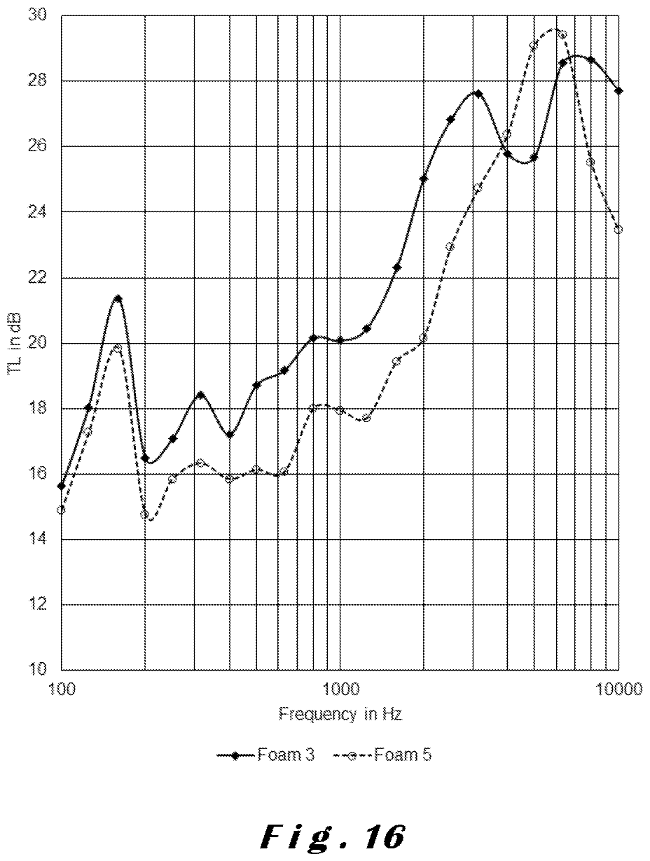

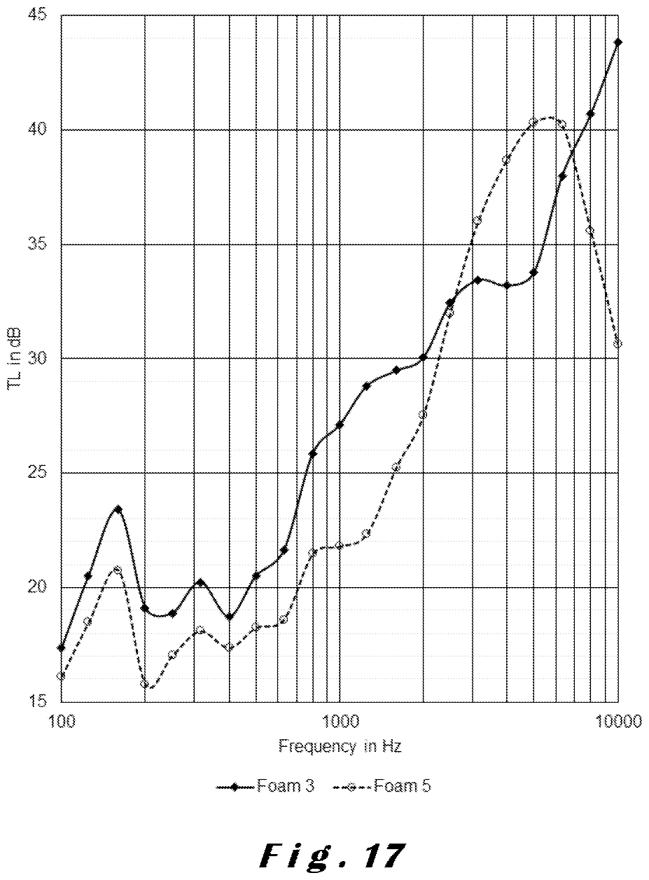

FIGS. 16 and 17 are graphs of the transmission losses obtained for two different foams in the coupled room experiments with a noise barrier having a honeycomb structure and a thickness of 100 mm and 200 mm, respectively; and

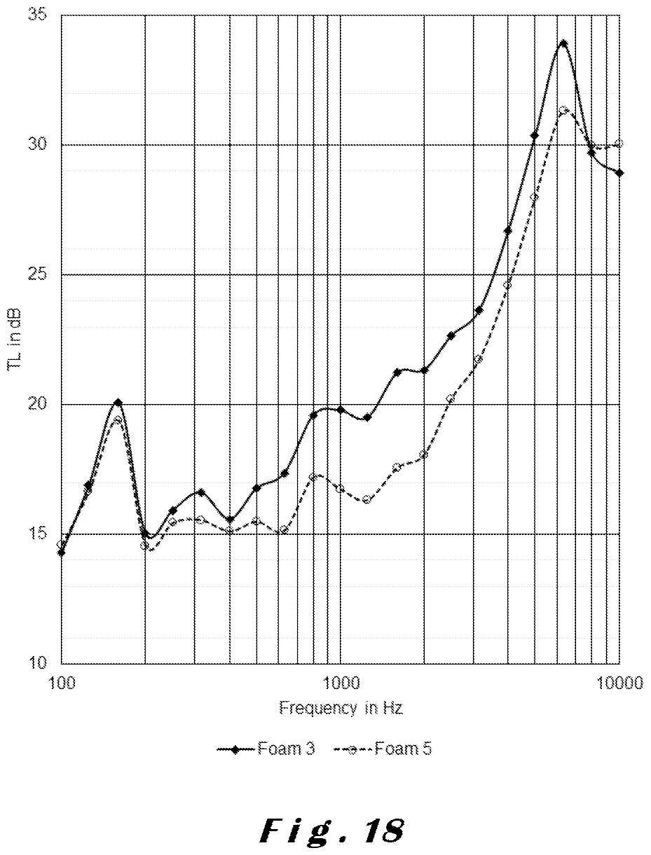

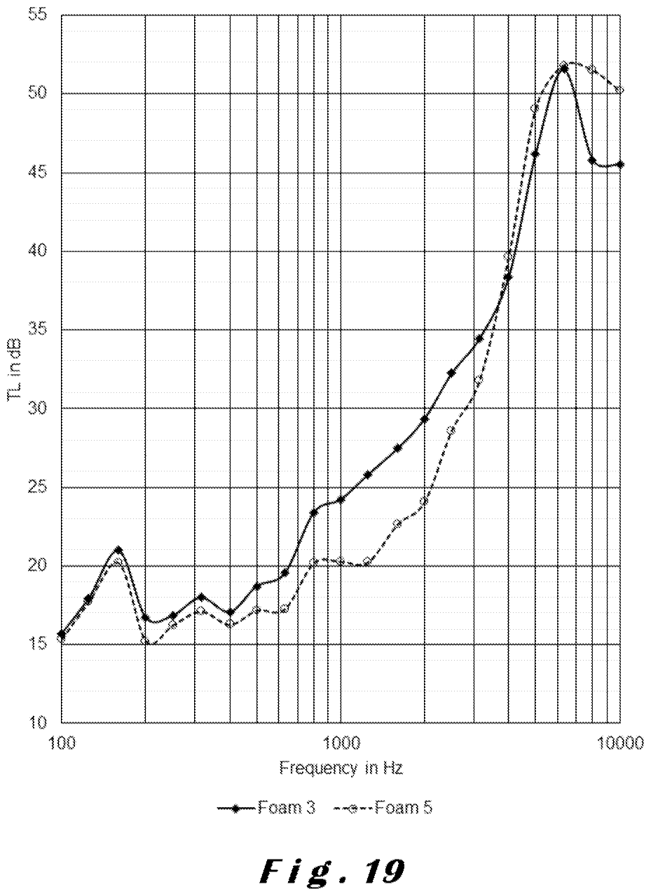

FIGS. 18 and 19 are graphs of the transmission losses obtained for two different foams in the coupled room experiments with a noise barrier having a V-shape, as illustrated in FIGS. 5 and 6, and a thickness of 100 mm, and respectively with a noise barrier having a W-shape, as illustrated in FIGS. 7 and 8, and a thickness of 200 mm.

The present invention generally relates to a noise barrier 1. The noise barrier 1 is configured to be placed in the path of an airflow and is provided with one or more through holes 2 to enable the airflow to pass through the noise barrier 1. The noise barrier 1 itself is made of a sound attenuating polymeric foam, preferably a polyurethane foam.

There are several applications of such a noise barrier 1, i.e. it can be applied in different types of apparatuses. FIG. 1 illustrates schematically such an apparatus. It generally has an enclosure 3 which is provided with an air inlet 4 and an air outlet 5. Within the enclosure 3 there is an airflow 6 from the air inlet 4 to the air outlet 5. The different apparatuses can be divided in three groups.

A first group comprises apparatuses which do not generate the airflow themselves. Those apparatuses may for example be ventilation devices which simply provide openings/channels for enabling an airflow to pass. The air may come for example from the outside and may flow through the ventilation device to the inside of for example a building. Noise generated outside the building, for example traffic noise, can thus be attenuated before it comes into the building.

Preferably, the apparatuses wherein the noise barrier is applied comprise at least one blower 7, in particular a ventilator, for generating the airflow 6 through the apparatus. Such apparatuses also produce noise. In particular, this noise may not only be produced by the blower 7 but also by other elements present in the apparatus.

The apparatus may be an air blowing and/or an air sucking apparatus configured to suck in air from the environment and/or to blow air into the environment. The apparatus may for example be a dust collector, in particular a vacuum cleaner, the air inlet 4 of which may be at the end of a hose. The apparatus may also be a HVAC apparatus (Heating Ventilating Air Conditioning). These have an inlet 4 for the air and an outlet 5 for the heated, cooled or dried (or humidified) air.

The apparatus may also be an air-cooled apparatus which comprises a device which needs to be cooled with air. It may comprise for example a combustion engine. It may also comprise a compressor, in particular an air compressor or a generator for producing electricity, which also generates heat so that these need to be cooled.

As described hereabove, the noise barrier 1 which is placed or which is to be placed in the path of said airflow 6, either at the location of the inlet 4, at the location of the outlet 5 or in between them, is made of a polymeric foam and has through holes 2 for enabling the airflow 6 to pass through the noise barrier 1. FIG. 2 schematically illustrates a cross-section of the noise barrier 1 at the location of a through hole 2. The through hole 2 has an inlet 8 and an outlet 9 which is smaller than the inlet 8. The through hole 2 has a mainly conical shape. It has a centreline 10 which is defined as the imaginary axis which runs longitudinally along the through hole 2 through the midpoint of its diameter. It is the line connecting the centres of gravity of the different cross-sections through the hole 2 according to planes which are perpendicular to the centreline 10.

In one of these planes, namely in plane α, the hole 2 has its smallest cross-sectional area. In FIG. 2, the smallest cross-sectional area of the hole 2 is at the location of its outlet 9 whilst the largest cross-sectional area of the hole 2 is at the location of its inlet 8, namely in plane β indicated in FIG. 2.

The surface section 11 of the noise barrier 1 which is hit by the airflow 6 has been provided in FIG. 2 with a surface relief, namely with pyramids. In order to define the orientation of this surface section 11, a plane γ has been fitted to this surface section 11, more particularly to the portion of this surface section which is situated between the inlets 8 of the through holes 2. This is done by a weighted total least-squares fitting technique. Such a technique is for example described in point 2.1 of the article “Diagnostic-robust statistical analysis for local surface fitting in 3D point cloud data” of A. Nurunnabi et al. in ISPR Annals of the Photogrammetry, Remote Sensing and Spatial Information Sciences, Volume 1-3, 2012, which is included herein by way of reference.

In accordance with the present invention the sum of the smallest cross-sectional areas of the different through holes 2 of the noise barrier 1, i.e. the open surface of the noise barrier, is larger than 10% of the surface area of the orthogonal projection of the surface section 11 on the plane γ fitted to this surface section 11. In this way, a substantial airflow 6 can pass through the noise barrier 1. The sum of the smallest cross-sectional areas of the different through holes 2 of the noise barrier 1 is preferably larger than 20%, more preferably larger than 30% of the surface area of the orthogonal projection of the surface section 11 on the plane γ. To keep the structural integrity of the noise barrier 1, and to limit the amount of noise which can pass therethrough, the sum of the smallest cross-sectional areas of the different through holes 2 of the noise barrier 1 is preferably smaller than 60%, more preferably smaller than 50% of the surface area of the orthogonal projection of the surface section 11 on the plane γ.

In the embodiment of FIG. 2, wherein the through holes 2 are generally conical, the through holes 2 have a circular shape in a cross-section perpendicular to their centreline 10. More generally, the through holes 2 have at the location of their smallest cross-sectional areas, and measured in said planes a perpendicular to their centrelines at their smallest cross-sectional area, a longest diameter passing through said centreline and a shortest diameter passing through said centreline, which shortest diameter is larger than 30%, preferably larger than 50% of said longest diameter. In this way, the mechanical strength of the polymeric foam can be optimally maintained. This is for example the case for the honeycomb structure, illustrated in FIGS. 3 and 4, wherein the through holes 2 are squared in cross-section.

In FIGS. 5 and 6 the through holes 2 are formed by elongated slots which are V-shaped in a longitudinal section through the noise barrier 1. In FIGS. 7 and 8 two of such noise barriers are combined to achieve a noise barrier having slots which are W-shaped in a longitudinal section. In these two embodiments, the through holes 2 have such a shape that no straight line passes through the through holes 2. In this way, more noise is absorbed by the polymeric foam since the noise cannot pass straight through the noise barrier but instead hits the walls of the through holes 2. In these embodiments, the centrelines 10 of the through holes 2 are not rectilinear and form an angle smaller than 80° with the plane γ fitted to the surface of the noise barrier 1 (which coincides in the case of FIGS. 3 to 8 with the surface of the noise barrier 1).

The through holes 2 are preferably cut in the polymeric foam so that the walls of the through holes are not formed by a more closed moulded skin and so that the sound absorption properties of the polymeric foam are the same at the location of the walls of the through holes. The noise is thus more effectively absorbed in the through holes themselves compared to moulded through holes.

In the embodiments illustrated in the different figures, the noise barrier 1 is made entirely of the polymeric foam, in particular of the polyurethane foam.

The problem to be solved with the noise barriers 1 to which the invention relates is that they should enable a sufficiently large flow of air through the noise barrier 1 while attenuating as much as possible the noise which is also transmitted along the path of the airflow. In accordance with the present invention it has been found, as demonstrated by the following examples, that notwithstanding the fact that a polymeric foam which has a high airflow resistivity reflects more noise and thus absorbs less noise, the noise barrier according to the present invention appeared to have better sound attenuating properties when the airflow resistivity of the polymeric foam was quite high, more particularly higher than 50 000 N.s/m⁴.

### EXAMPLES

### Foams

The following polyurethane foam were used in the examples.
Foam 1: dBR® Seal M50 flexible polyurethane foam with a semi-closed cell structure (commercially available from Recticel); density around 50 kg/m³, air flow resistivity around 400 000 Ns/m⁴, dynamic Young's modulus on average around 100 kPa, static/bending Young's modulus around 30 kPa; open porosity: 0.95, tortuosity around 3.0.
Foam 2: Airseal P130X flexible polyurethane foam with a semi-closed cell structure (commercially available from Recticel); density around 30 kg/m³, air flow resistivity around 220 000 Ns/m⁴, dynamic Young's modulus on average around 350 kPa, static/bending Young's modulus around 93 kPa; open porosity: 0.99, tortuosity around 3.0.
Foam 3: Fireflex S606 flexible polyurethane foam with a semi-closed cell structure (commercially available from Recticel); density around 52 kg/m³, air flow resistivity around 85 000 Ns/m⁴, dynamic Young's modulus on average around 150 kPa, static/bending Young's modulus around 140 kPa; open porosity: 0.92, tortuosity around 1.9.
Foam 4: D28160 dBR flexible polyurethane foam with a semi-closed cell structure (commercially available from Recticel); density around 25 kg/m³, air flow resistivity around 140 000 Ns/m⁴, dynamic Young's modulus on average around 350 kPa, static/bending Young's modulus around 90 kPa; open porosity: 0.96, tortuosity around 2.2.
Foam 5: Fireflex T30 flexible polyurethane foam with a semi-closed cell structure (commercially available from Recticel); density around 26 kg/m³, air flow resistivity around 15 000 Ns/m⁴, static/bending Young's modulus around 70 kPa; open porosity: 0.94, tortuosity around 1.7.
Foam 6: Fireflex S305 flexible polyurethane foam with a semi-closed cell structure (commercially available from Recticel); density 30 kg/m³, air flow resistivity around 5000 Ns/m⁴, static/bending Young's modulus around 94 kPa.
Foam 7: D26120 flexible polyurethane foam with a semi-closed cell structure (commercially available from Recticel); density 24 kg/m³, air flow resistivity around 6 000 Ns/m⁴, static/bending Young's modulus around 79 kPa.

### COUPLED ROOM EXAMPLES

Noise barriers were made having a width of 740 mm and a length of 830 mm. Transmission losses were measured in coupled room experiments following the EN ISO 15186-1 (2003) standard. The emission room was a reverberant room containing the source of sound, the reception room was a hemi-anechoic room containing microphones to measure the sound intensity. The sound transmission between the two rooms only occurred through the noise barrier.

Noise barriers having a honeycomb structure as illustrated schematically in FIGS. 3 and 4 (not on scale, the holes had more particularly a smaller cross-section than illustrated in these figures) were made with Foam 3 and Foam 5. The straight square holes had a constant cross-sectional area of about 36 cm² (6×6 cm). The surface area of the holes was equal to 24.7% of the total surface area of the noise barrier. The noise barriers were made in thicknesses of 100 mm and 200 mm.

FIG. 16 shows the transmission loss values obtained with the honey comb noise barriers having a thickness of 100 mm. It can be seen that the transmission losses that are obtained are larger for Foam 3 than for Foam 5. The transmission losses obtained with a noise barrier of 200 mm, which are shown in the graph in FIG. 17, are considerably higher. Foam 3 again offers better acoustic properties than Foam 5. This was due to the higher airflow resistivity of Foam 3. The AFR of Foam 3 was indeed about 85 000 Ns/m⁴ whilst the AFR of Foam 5 was only equal to about 15 000 Ns/m⁴.

Noise barriers having a V-shape structure as illustrated in FIGS. 5 and 6 were made with Foam 3 and Foam 5. The noise barriers had a thickness of 100 mm. The V-shaped slots had a width of 33 mm and their inlets (measured in the plane of the front side of the noise barrier) formed 41.1% of the total surface of the noise barrier.

The transmission loss values are indicated for both foams in FIG. 18. It can be seen that similar transmission loss values can be obtained as with the honeycomb structures, having the same thickness, notwithstanding the fact that the total surface area of the inlets of the slots (41.1%) is much larger than the total surface area of the inlets of the honeycomb structure (24.7%). Again, Foam 3 offered considerably better acoustic attenuating properties than Foam 5.

Noise barriers having a W-shape structure as illustrated in FIGS. 7 and 8 were made with Foam 3 and Foam 5. This was done by putting two noise barriers have the V-shaped structure on top of one another. The noise barriers thus had a thickness of 200 mm.

It can be seen from FIG. 19 that this increased thickness offered again better acoustic properties, and that Foam 3 was again better than Foam 5. The W-shaped structure appeared to provide much better acoustic properties than the honeycomb structure having the same thickness.

### IMPEDANCE TUBE EXAMPLES

Cylindrical noise barriers were made having a diameter of 100 mm and a thickness of 45 mm. Transmission losses were measured following the ASTM E2611-17 standard for the transfer matrix method with the impedance tube.

Noise barriers having 4 straight cylindrical holes having a diameter of 15 mm (see FIG. 11a), forming thus about 10% open surface, were made with foams 1 to 7. The results of the transmission loss experiments are given in FIG. 14. Just as in the coupled room experiments, Foam 3 appeared to perform much better than Foam 5. In general, one group of foams appeared to perform better than the other foams, namely the group of foams 1, 2, 3 and 4. All of these foams had a higher AFR (air flow resistivity) than the other foams. Also within this group of foams, the transmission loss values increased with increasing AFR values.

Foams 2 and 4 showed a maximum transmission loss or a peak for frequencies around 1000 to 1250 Hz. They both had a dynamic Young's modulus of around 350 kPa. For such frequencies and higher, Foams 1 and 3 provided much better results. They had a dynamic Young's modulus respectively around 100 kPa and 150 kPa.

Further tests were done with noise barriers made of six of the different foams (no test was done with Foam 2) having however more holes, namely 20 cylindrical holes of 15 mm diameter, forming thus about an open surface of 45%. The results of the transmission loss experiments are given in FIG. 15. Foam 1 was again the best foam, but also Foams 3 and 4, which had a lower AFR value than Foam 1, were better than the other foams.

Although Foam 1 gave the best acoustic performance results, Foam 3 may be the preferred foam material for producing the noise barrier. It has indeed a much higher static/bending Young's modulus so that the noise barrier will have a better mechanical strength to resist to the airflow. Moreover, it has a relatively low dynamic Young's modulus so that no maximum/peak is achieved in the low frequency range (see FIG. 14) and even not at higher frequencies (apart from a small peak which may be due to resonance effects of the foam structure itself).

Different tests were done on noise barriers with different foams having open surfaces of 10, 20, 30, 45 and 55% obtained with straight cylindrical holes with diameters of 5, 10, 15, 20 and 25 mm (no tests were done for the combination of 5 mm holes with an open surface of 55% since it was not feasible to produce such a noise barrier). It appeared that the increase of the size of the holes had a less negative effect on the transmission loss values than an increase of the open surface. Since larger holes offer relatively less resistance to the airflow than smaller holes, for a same percentage of open surface, it thus appeared to be advantageous to provide less but larger holes.

In Table 1 the global transmission loss values, calculated over the same frequency range as in the previous examples, namely from 80 to 2000 Hz, are given for noise barriers, made of Foam 1 and having an open surface of about 10% provided with cylindrical holes of 5 mm (FIG. 9), 10 mm (FIG. 10), 15 mm (FIG. 11a), 20 mm (FIG. 12) and 25 mm (FIG. 13).

TABLE 1
global transmission losses obtained with noise
barriers made of Foam 1 having the same open surface
(about 10%) but different sizes of holes.

| Hole diameter (mm) | Number of holes | Global TL (in dB) |
|---|---|---|
| 5 | 40 | 7.95 |
| 10 | 10 | 7.40 |
| 15 | 4 | 8.21 |
| 20 | 3 | 6.59 |
| 25 | 2 | 6.99 |

In Table 2 the global transmission loss values, calculated over the same frequency range as in the previous examples, namely from 80 to 2000 Hz, are given for noise barriers, made of Foam 1, provided with cylindrical holes of 15 mm and having an open surface of about 10, 20, 30, 45 and 55%.

TABLE 2
global transmission losses obtained with noise
barriers made of Foam 1 having the same size
of holes (15 mm) but different % open surface

| Open surface (%) | Number of holes | Global TL (in dB) |
|---|---|---|
| 10 | 4 | 8.21 |
| 20 | 8 | 4.17 |
| 30 | 12 | 2.62 |
| 45 | 20 | 1.31 |
| 55 | 25 | 0.86 |

It can be seen from Table 1 that, when increasing the diameter of the holes from 5 to 15 mm (or even bigger), and when at the same time reducing the number of holes from 40 to 4 (or even less), the global transmission loss as measured with the impedance tube substantially remained the same. Increasing the size of the holes reduces however the airflow resistance thereof. Consequently, when the noise barrier has to have a certain (maximum) airflow resistance (for a certain relatively high airflow), it is better to provide less but larger holes, which would also enable to reduce the open surface of the noise barrier which was found to have a considerable effect on the noise attenuating properties of the noise barrier, as can be seen from Table 2.

1. A noise barrier configured to be placed in a path of an airflow for attenuating sound which propagates along the path in the airflow, the noise barrier has one or more through holes to enable said airflow to pass through the noise barrier, the noise barrier being made of at least one sound attenuating polymeric foam and having one side configured for being contacted by air of said airflow over a surface section which has a predetermined surface area in an orthogonal projection on a plane fitted to said surface section,
wherein said polymeric foam has an airflow resistivity, measured in accordance with ISO 9053-1:2018, Part 1, which is higher than 50 000 Ns/m⁴, and
wherein said one or more through holes have each a centreline and a smallest cross-sectional area, measured in a plane perpendicular to the centreline, a sum of said smallest cross-sectional areas being larger than 10% of said predetermined surface area.

2. The noise barrier according to claim 1, wherein said polymeric foam is a polyurethane foam.

3. The noise barrier according to claim 1, wherein said polymeric foam has an open porosity of at least 80%, as measured according to the publication “Méthode de la masse manquante” as published in the Journal of Applied Physics 101 (12), 2007.

4. The noise barrier according to claim 1, wherein said polymeric foam has a dynamic Young's modulus, measured in accordance with ISO 18437-5:2011, lower than 400 kPa.

5. The noise barrier according to claim 1, wherein said airflow resistivity is higher than 70 000 Ns/m⁴.

6. The noise barrier according to claim 1, wherein airflow resistivity is lower than 1 000 000 Ns/m⁴.

7. The noise barrier according to claim 1, wherein said polymeric foam has a dynamic Young's modulus, measured in accordance with ISO 18437-5:2011, lower than 250 kPa.

8. The noise barrier according to claim 1, wherein said polymeric foam has a static Young's modulus, measured in accordance with ISO 14125:1998/Amd 1:2011, higher than 20 kPa.

9. The noise barrier according to claim 1, wherein the sum of said smallest cross-sectional areas is larger than 20% of said predetermined surface area.

10. The noise barrier according to claim 1, wherein the sum of said smallest cross-sectional areas is smaller than 60% of said predetermined surface area.

11. The noise barrier according to claim 1, wherein said through holes have at the smallest cross-sectional area, and measured in said plane perpendicular to the centreline at the smallest cross-sectional area, a longest diameter passing through said centreline and a shortest diameter passing through said centreline, which wherein said shortest diameter is larger than 30% of said longest diameter.

12. The noise barrier according to claim 1, wherein more than 80% of the sum of said smallest cross-sectional areas is formed by less than 20 of the through holes which have the largest ones of said smallest cross-sectional areas.

13. The noise barrier according to claim 1, wherein said through holes have an inlet and an outlet for said airflow, and comprise through holes which have a cross-sectional area, measured in a plane perpendicular to the centreline at the inlet which is larger than the cross-sectional area, measured in a plane perpendicular to the centreline at the outlet.

14. The noise barrier according to claim 1, wherein said through holes comprise through holes having such a shape that no straight line passes through the through holes.

15. The noise barrier according to claim 1, wherein through holes comprise through holes having a centreline which is non-rectilinear and/or which forms an angle smaller than 80° with said fitted plane.

16. The noise barrier according to claim 1, wherein said through holes are made of material removed from said foam, said through holes being cut in said foam.

17. The noise barrier according to claim 1, wherein the noise barrier substantially comprises said polymeric foam.

18. The noise barrier according to claim 1, wherein said foam has a density of less than 100 kg/m³.

19. The noise barrier according to claim 1, which is placed in the path of an airflow for attenuating sound propagated along the path.

20. The noise barrier according to claim 1, wherein said one or more through holes comprise at least one through hole of which said smallest cross-sectional area is larger than 0.2 cm².

21. An apparatus which produces noise during operation and which comprises at least one blower for generating an airflow along a path through the apparatus,
wherein said apparatus comprises a noise barrier according to claim 1, wherein the noise barrier is placed in said path of said airflow.

22. The apparatus according to claim 21, wherein said apparatus is an air-cooled apparatus which is cooled by said airflow.

23. The apparatus according to claim 21, wherein said apparatus is an air blowing and/or an air sucking apparatus configured to suck in air from an environment and/or to blow air into the environment, the apparatus being a dust collector or a heating and/or a cooling apparatus.
